(19) United States
(12) Patent Application Publication
(10) Pub. No.: US 2006/0151549 A1
(43) Pub. Date: Jul. 13, 2006

(54) Agricultural spreading device

(76) Inventors: David G. Fisher, Bird-In-Hand, PA (US); David R. Esh, Gordonville, PA (US)

Correspondence Address: BARLEY SNYDER, PO BOX 1559, LANCASTER, PA, 17608-1559, US

(21) Appl. No.: 11/035,116

(22) Filed: Jan. 12, 2005

(51) Int. Cl. A01M 7/00

(52) U.S. Cl. 222/613

(57) ABSTRACT

An agricultural spreading device comprises a hopper having an inclined surface leading into a bottom surface formed with a plurality of elongated slots. A dispensing device is arranged in the hopper adjacent to the bottom surface and has a plurality of rotatable arms for engaging a spreadable material. A baffle is rotatably mounted in the hopper. The baffle is rotatable between a first position where a bottom edge of the baffle engages the inclined surface and a second position where a gap is created between the inclined surface and the bottom edge. The baffle limits advancement of the spreadable material toward the elongated slots. A slideable dispensing plate is mounted to the hopper adjacent to the bottom surface and has a plurality of dispensing slots corresponding to the elongated slots. A plate actuating mechanism is attached to the dispensing plate for positioning the dispensing slots relative to the elongated slots.

### FIELD OF THE INVENTION

The invention relates to an agricultural spreading device and, more particularly, to an agricultural spreading device comprising a baffle, a dispensing device, and a dispensing plate for controlling the size, shape, and amount of spreadable material, such as pulverized lime, seed, fertilizer, etc., dispersed from the agricultural spreading device during spreading.

### BACKGROUND OF THE INVENTION

In a typical farming environment, it is necessary to spread various materials, such as pulverized lime, seed, fertilizer, etc., over tracts of land. To spread the material, it is common to put the material in a hopper. The hopper typically has a bottom surface with openings for dispensing the material onto the land as the hopper is being pulled. Sidewalls extend upward from the bottom surface. The sidewalls are all inclined toward the bottom surface to direct the material toward the openings. A dispensing plate is positioned adjacent to the openings for controlling the amount of the material dispensed through the openings. The hopper may also have an agitator proximate the bottom surface that rotates to dispense the materials through the openings.

In the above-described hopper, all of the material is being directed toward the agitator and the bottom surface by the sidewalls. Because the material has a significant weight, the material can damage the agitator and/or prevent the agitator from properly rotating. Additionally, depending on the configuration of the agitator and the size and shape of the openings, the material may be dispensed in clumps. If the material is dispensed in clumps, then the material will not be effectively spread onto the land. Hoppers, such as the one described above, are also often heavy and bulky and require a large piece of equipment to pull.

### SUMMARY OF THE INVENTION

The invention is generally an agricultural spreading device comprising a hopper, a dispensing device, and a baffle. The hopper has an inclined surface leading into a bottom surface. The bottom surface is formed with a plurality of elongated slots. The dispensing device is arranged in the hopper adjacent to the bottom surface and has a plurality of rotatable arms for engaging a spreadable material. The baffle is rotatably mounted in the hopper. The baffle is rotatable between a first position where a bottom edge of the baffle engages the inclined surface and a second position where a gap is created between the inclined surface and the bottom edge. The baffle limits advancement of the spreadable material toward the elongated slots. The agricultural spreading device may additionally have a slideable dispensing plate mounted to the hopper adjacent to the bottom surface. The dispensing plate has a plurality of dispensing slots corresponding to the elongated slots. A plate actuating mechanism is attached to the dispensing plate. The plate actuating mechanism positions the dispensing slots relative to the elongated slots to regulate the amount of the spreadable material that passes through the elongated slots.

### BRIEF DESCRIPTION OF THE DRAWINGS

FIG. 1 is a perspective view of an agricultural spreading device;

FIG. 2 is a sectional view taken along line 2-2 of FIG. 1;

FIG. 3 is a partial sectional view of the agricultural spreading device showing a cover of a hopper in an open position;

FIG. 4 is a sectional view taken along line 4-4 of FIG. 1;

FIG. 5 is a sectional view taken along line 5-5 of FIG. 4;

FIG. 6 is a partial sectional view of the agricultural spreading device showing a dispensing device mounted proximate a bottom surface of the hopper; and

FIG. 7 is partial exploded view of the attachment of a dispensing plate to the bottom surface of the hopper.

### DETAILED DESCRIPTION OF THE INVENTION

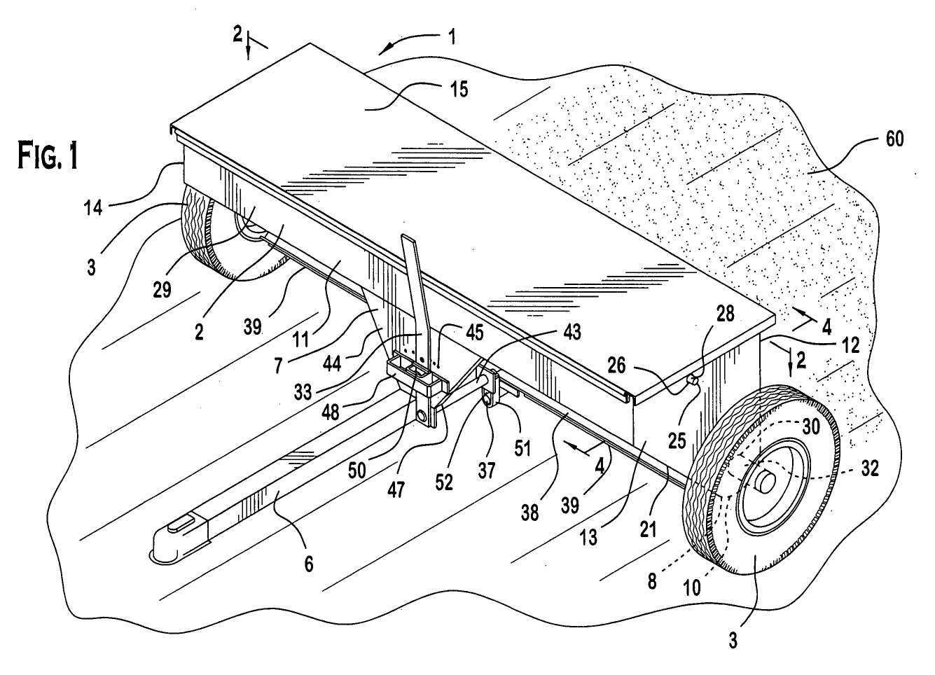

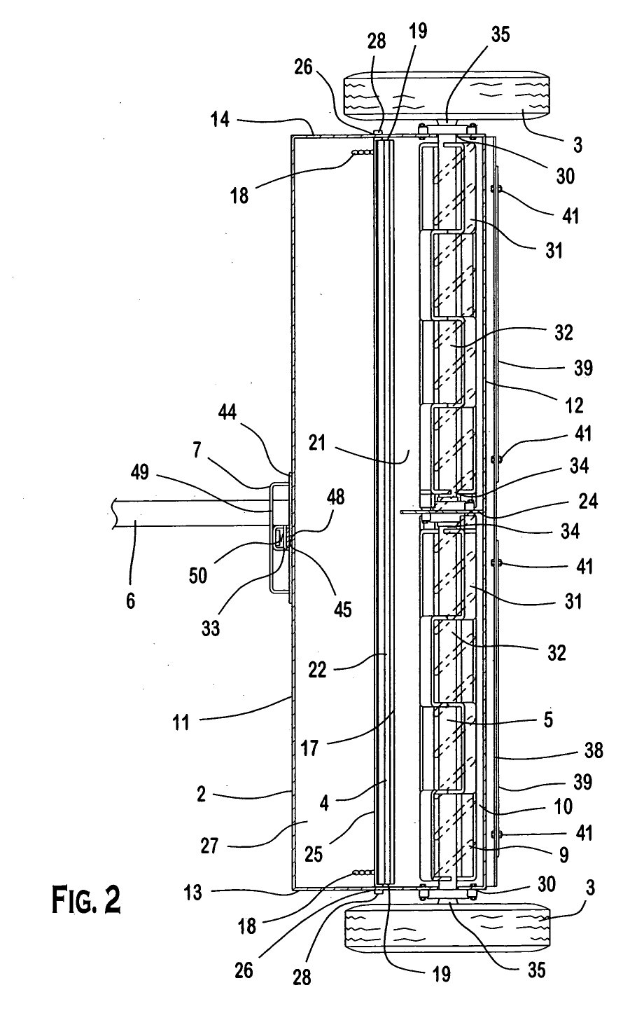

FIG. 1 shows an agricultural spreading device 1. The agricultural spreading device 1 comprises a hopper 2 mounted on a pair of wheels 3. As shown in FIG. 2, the hopper 2 includes a baffle 4 and a dispensing device 5. As shown in FIG. 1, a draw bar 6 extends from the hopper 2. A plate actuating mechanism 7 is attached to the hopper 2 and controls the movement of a dispensing plate 8 attached thereto. The individual elements of the agricultural spreading device 1 will now be described in greater detail.

As shown in FIG. 1, the hopper 2 may be formed from a rigid material, such as metal, to have a bottom surface 10 and first, second, third, and fourth sidewalls 11, 12, 13, 14, respectively, that extend upward from the bottom surface 10. The bottom surface 10 has an arcuate configuration. Although in the illustrated embodiment, the bottom surface 10 has an arcuate configuration, it will be appreciated by those skilled in the art that the bottom surface may have other known configurations. The first side wall 11 has an inclined surface 21 leading into the bottom surface 10. The second, third and fourth sidewalls 12, 13, 14 extend substantially perpendicular to the bottom surface 10. The third and fourth sidewalls 13, 14 each have a rod receiving aperture 26 and a shaft receiving aperture 30. As shown in FIGS. 2 and 6, the bottom surface 10 has a plurality of elongated slots 9. The elongated slots 9 are formed between the third and fourth sidewalls 13, 14 and extend from an internal surface 27 to an external surface 29 of the hopper 2. The elongated slots 9 are approximately equally spaced and are substantially parallel relative to each other. As shown in FIG. 2, a divider 24 extends from an approximate center of the bottom surface 10, and a support bar (not shown) extends between the first and second side walls 11, 12.

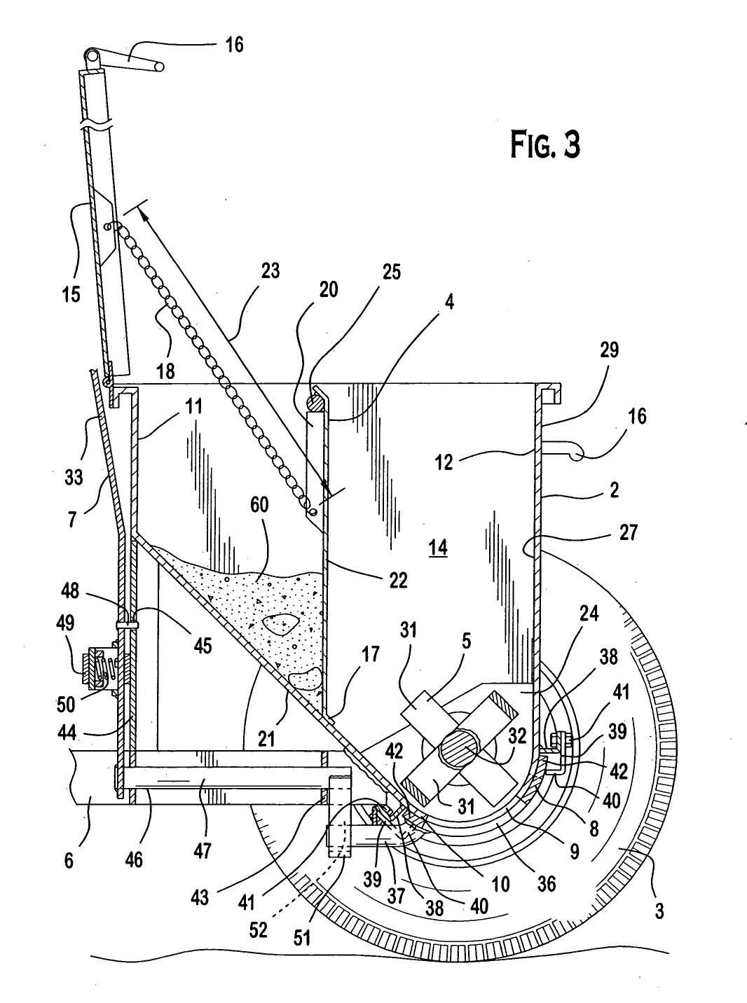

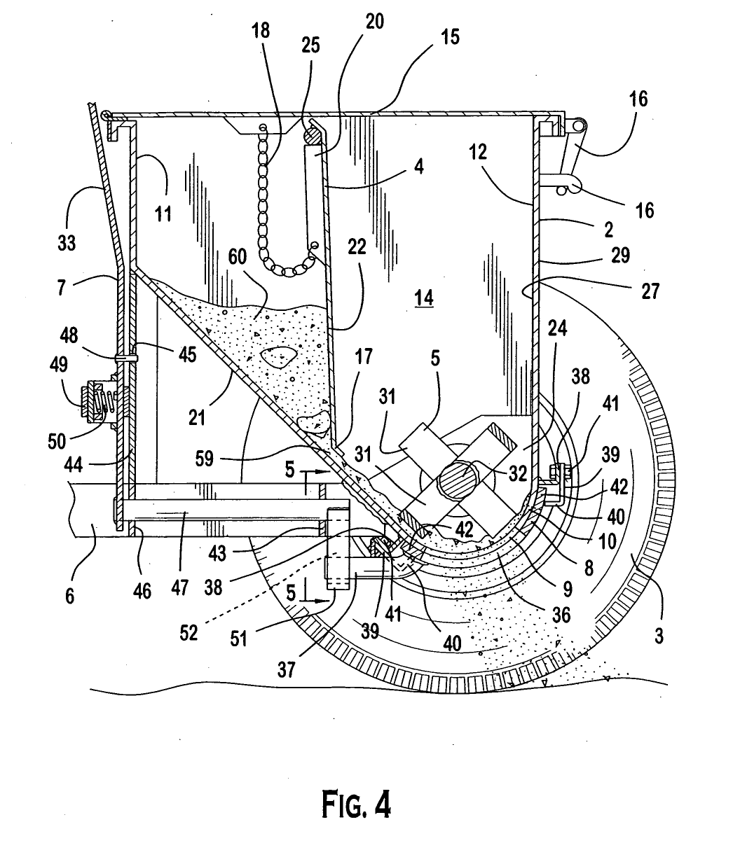

As shown in FIGS. 3-4, a cover 15 is rotatably mounted to the hopper 2. The cover 15 rotates between an open position shown in FIG. 3 and a closed position shown in FIG. 4. Although in the illustrated embodiment, the cover 15 is shown as being rotatably mounted to the hopper 2 by a hinge, it will be appreciated by those skilled in the art that other known methods for mounting the cover 15 may be used. The cover 15 and/or the hopper 2 has a locking device 16 for securing the cover 15 to the hopper 2 when the cover 15 in the closed position. Although in the illustrated embodiment, the locking device 16 is shown as being a clip, it will be appreciated by those skilled in the art that other known locking devices may be used.

As shown in FIGS. 2-4, the baffle 4 is a substantially elongated plate 22 integrally formed with a support rod 25. Ends 28 of the support rod 25 are positioned in the rod receiving apertures 26 to rotatably mount the baffle 4 in the hopper 2. The baffle 4 is rotatable between a first position shown in FIG. 3 and a second position shown in FIG. 4. In the first position, a bottom edge 17 of the baffle 4 rests on the inclined surface 21 of the first side wall 11, and side edges 19 of the baffle 4 are positioned adjacent to the third and fourth sidewalls 13, 14. In the illustrated embodiment, the bottom edge 17 is angled approximately parallel to the inclined surface 21. In the second position, a gap 59 is created between the inclined surface 21 and the bottom edge 14 of the baffle 4. Although in the illustrated embodiment, the baffle 4 is mounted by the support rod 25 being positioned in the rod receiving apertures 26, it will be appreciated by those skilled in the art that other known methods for rotatably mounting the baffle 4 may be used. Tabs 20 extend from the side edges 19 of the baffle 4. Positioning members 18 extend from the tabs 20 and are attached to the cover 15. The positioning members 18 may be, for example, chains, ropes, cables, hinges, or any other device which can be used to position. Each of the positioning members 18 has a length 23 such that when the cover 15 is in the open position shown in FIG. 3, the positioning members 18 retain the bottom edge 17 of the baffle 4 against the inclined surface 21 of the first side wall 11.

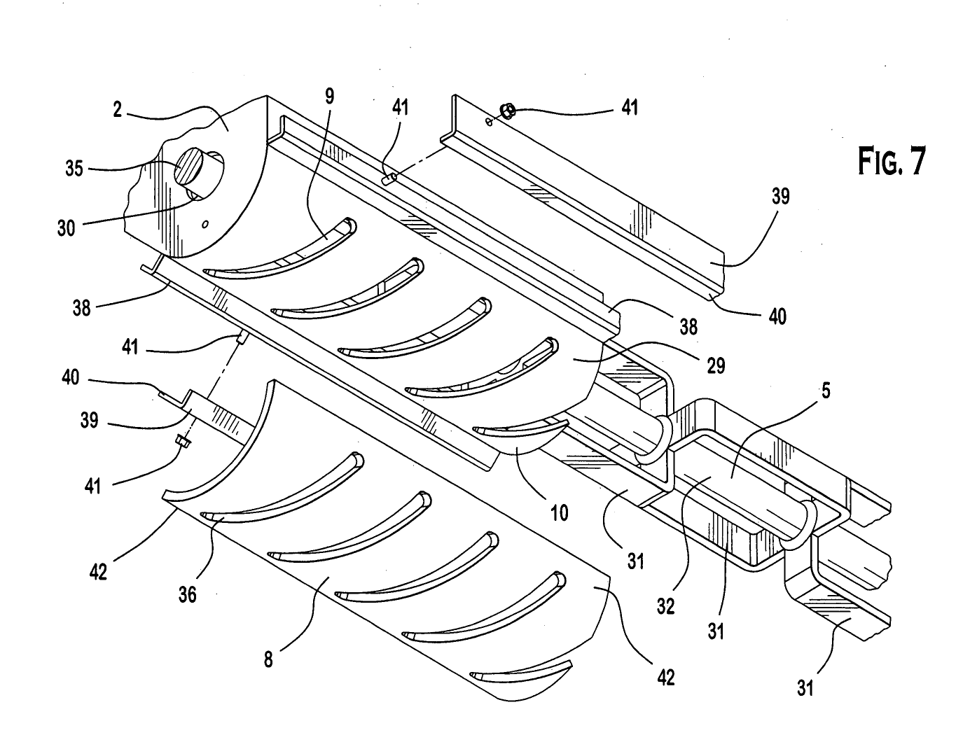

As shown in FIG. 2, the dispensing device 5 is arranged in the hopper 2 adjacent to the bottom surface 10. The dispensing device 5 consists of a pair of shafts 32. A plurality of arms 31 are attached to each of the shafts 32. As shown in FIGS. 6-7, the arms 31 are substantially square in shape and adjacent ones of the arms 31 are arranged substantially perpendicular to one another. It will be appreciated by those skilled in the art, however, that the arms 31 may be formed and arranged in other configurations. As shown in FIG. 2, each of the shafts 32 has a first end 34 rotatably mounted to the divider 24 and a second end 35 that extends through a corresponding one of the shaft receiving apertures 30. It will be appreciated by those skilled in the art, however, that other known methods for mounting the shafts 32 may be used. The dispensing device 5 is mounted such that the arms 31 are positioned proximate the elongated slots 9 formed in the bottom surface 10. A conventional wheel 3 is attached to each of the second ends 35 of the shafts 32 such that the shafts 32 are rotated by movement of the wheels 3. Although in the illustrated embodiment, the dispensing device 5 is rotated by the wheels 3, it will be appreciated by those skilled in the art that other known methods for rotating the shaft 32 may be used.

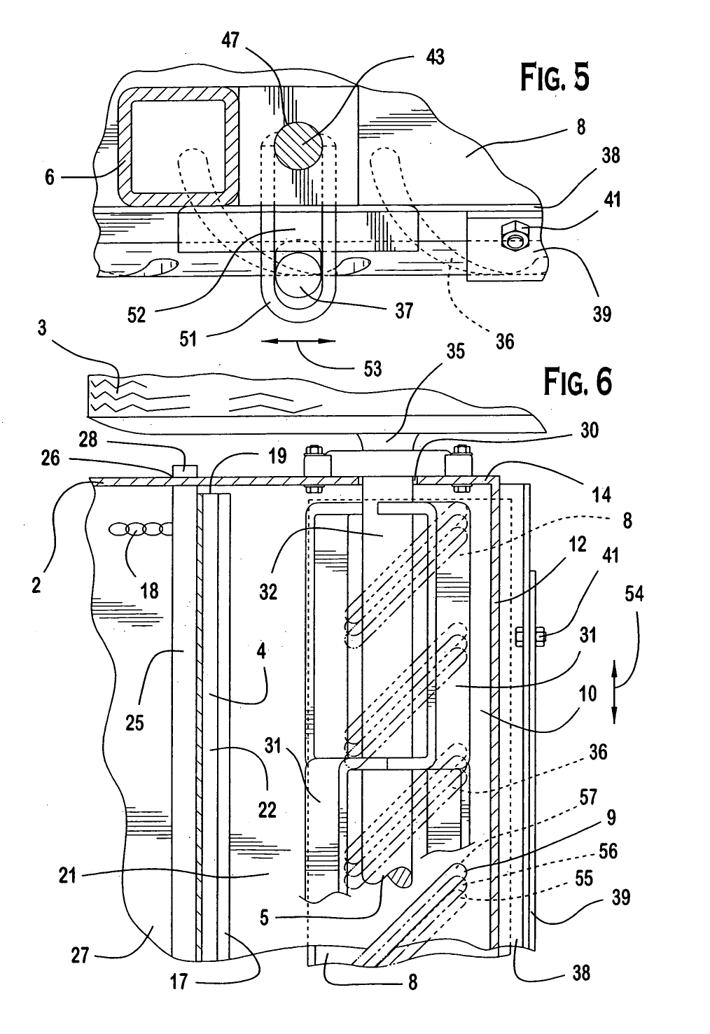

As shown in FIGS. 1 and 3, the plate actuating mechanism 7 consists of a support member 44 and a lever 33. The support member 44 extends from the external surface 29 of the first sidewall 11. The support member 44 has plurality of positioning apertures 45 formed in an arcuate configuration. At a bottom of the support member 44 is a rod receiving aperture 46. An actuation rod 47 extends through the rod receiving aperture 46. The lever 33 is pivotally mounted to the actuation rod 47. A positioning projection 48 corresponding to the positioning apertures 46 extends from the lever 33. The positioning projection 48 is formed to engage with the positioning apertures 46 as the lever 33 is pivoted. A limit stop 49 having a substantially C-shaped configuration is attached to the support member 44 adjacent to the lever 33. The limit stop 49 prevents the lever 33 from pivoting beyond a range of the positioning apertures 46 and secures the lever 33 proximate the support member 44. A biasing member 50 is positioned between the limit stop 49 and the lever 33. The biasing member biases the lever 33 toward the support member 44. Although in the illustrated embodiment, the biasing member 50 is shown as being a spring, it will be appreciated by those skilled in the art that other known biasing members may be used. An upper end of an actuation member 51 is attached to a distal end 43 of the actuation rod 47. As shown in FIG. 5, the actuation member 51 is substantially elongated in configuration and has an opening 52.

As shown in FIGS. 3 and 7, the dispensing plate 8 has a substantially arcuate configuration corresponding to the arcuate configuration of the bottom surface 10 of the hopper 2. A plurality of dispensing slots 36 are formed in the dispensing plate 8. The dispensing slots 36 correspond to the elongated slots 9 and are substantially the same size and shape as the elongated slots 9. The dispensing plate 8 is mounted to the hopper 2 adjacent to and in contact with the external surface 29 of the bottom surface 10 of the hopper 2 by a pair of first and second mounting brackets 38, 39, respectively. The first mounting brackets 38 are attached to the external surface 29 of hopper 2 proximate the bottom surface 10. The second mounting brackets 39 are attached to the first mounting brackets 38 by attachment members 41. Each of the second mounting brackets 39 has a flange 40 that supports an end portion 42 of the dispensing plate 8. The dispensing plate 8 is supported on the flanges 40 such that the dispensing plate is capable of sliding in a direction indicated by arrow 54 in FIG. 6. Although in the illustrated embodiment, the dispensing plate 8 is mounted to the hopper 2 by the first and second brackets 38, 39, it will be appreciated by those skilled in the art that other known methods for mounting the dispensing plate 8 may be used. A control rod 37 extends from the dispensing plate 8 and is received in the opening 52 of the actuation member 51, as shown in FIGS. 3 and 5.

As shown in FIG. 1, a draw bar 6 extends from the hopper 2. The draw bar 6 is formed for attachment to a wide variety of vehicles, including small tractors, all terrain vehicles, trucks, work animals, etc. The draw bar 6 may also be formed to be adjustable with regard to length or angle. Because the draw bar 6 is well known in the art, the drive bar 6 will not be discussed in further detail herein.

The operation of the agricultural spreading device 1 will now be described in greater detail. The draw bar 6 is attached to a vehicle (not shown), such as, a small tractor, all terrain vehicle, truck, work animal, etc. An operator (not shown) positions the cover 15 in the open position shown in FIG. 3. A desired spreadable material 60, such as pulverized lime, fertilizer, seed, etc., is poured between the baffle 4 and the first side wall 11. Because the cover 15 is in the open position, the positioning members 18 prevent the baffle 4 from rotating and thereby contain the spreadable material 60 between the baffle 4 and the first side wall 11. The cover 15 is then rotated to the closed position shown in FIG. 4 and secured to the hopper 2 by the locking device 16. In the closed position, the rotation of the baffle 4 is no longer constrained by the positioning members 18. As shown in FIG. 4, the weight of the spreadable material 60, which is biased toward the bottom edge 14 of the baffle 4 by the inclined surface 21, causes the baffle 4 to rotate away from the inclined surface 21. As the baffle 4 rotates, the gap 59 is created between the inclined surface 21 and the bottom edge 14 of the baffle 4. The gap 59 allows a limited amount of the spreadable material 60 to advance toward the bottom surface 10 of the hopper 2.

As the operator (not shown) drives the vehicle (not shown), the wheels 3 cause the dispensing device 5 attached thereto to rotate. As the spreadable material 60 advances toward the bottom surface 10, the spreadable material 60 engages the rotating arms 31 of the dispensing device 5. The arms 31 break-up any clumps in the spreadable material 60 as the spreadable material 60 is advanced toward the elongated slots 9 by the inclined surface 21 and the arms 31. Because the bottom surface 10 has an arcuate configuration, the arms 31 may be positioned close to and above the elongated slots 9 to facilitate the removal of clumps in the spreadable material 60. Additionally, the size and shape of the elongated slots 9 prevent any large clumps from being dispensed from the hopper 2 before the arms 31 break them up. The spreadable material 60 then falls through the elongated slots 9 and out of the bottom surface 10 of the hopper 2.

To regulate the amount of spreadable material 60 that falls through the elongated slots 9, the operator (not shown) can alter the position of the dispensing slots 36 relative to the elongated slots 9 by actuating the dispensing plate 8. For example, the dispensing slots 36 may be positioned such that the elongated slots 9 are completely closed 55, partially open 56, or completely open 57, as shown in FIG. 5. To actuate the dispensing plate 8, the lever 33 is pivoted to move the positioning projection 48 into a desired one of the positioning apertures 45. The biasing member 50 secures the positioning projection 48 in the desired positioning aperture 45. As the lever 33 is pivoted, the actuation rod 47 attached thereto pivots the actuation member 51 and thus the control rod 37 in a direction indicated by arrow 53 shown in FIG. 5. Because the control rod 37 is attached to the dispensing plate 8, as the control rod 37 is pivoted, the dispensing plate 8 slides in a direction corresponding to the movement of the actuation member 51 to position the dispensing slots 36 in a desired position relative to the elongated slots 9.

The agricultural spreading device 1 comprising the baffle 4, the dispensing device 5, and the dispensing plate 8 thereby effectively controls the size, shape, and amount of the spreading material 60 that is dispersed from the hopper 2 during spreading. Additionally, because the arms 31 of the dispensing device 5 are substantially square shaped, the arms 31 have increased strength characteristics, which prevent the arms 31 from bending or breaking.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. An agricultural spreading device, comprising:
a hopper having a bottom surface with a plurality of elongated slots, the hopper having an inclined surface leading into the bottom surface;
a dispensing device arranged in the hopper adjacent to the bottom surface, the dispensing device having a plurality of rotatable arms for engaging a spreadable material; and
a baffle mounted in the hopper for limiting advancement of the spreadable material toward the elongated slots, the baffle being rotatable between a first position where a bottom edge of the baffle engages the inclined surface and a second position where a gap is created between the inclined surface and the bottom edge.

2. The device of claim 1, further comprising a slideable dispensing plate mounted to the hopper adjacent to the bottom surface, the dispensing plate having a plurality of dispensing slots corresponding to the elongated slots.

3. The device of claim 1, wherein the bottom surface has an arcuate configuration.

4. The device of claim 1, wherein the hopper is formed from metal.

5. The device of claim 1, wherein the elongated slots are substantially parallel relative to each other.

6. The device of claim 1, further comprising at least one positioning member that retains the baffle in the first position.

7. The device of claim 6, wherein the hopper includes a cover, the cover being rotatable between an open position and a closed position, the positioning member being attached to the cover such that the baffle is retained when the cover is in the open position.

8. The device of claim 1, wherein the arms are substantially square in shape and adjacent ones of the arms are arranged substantially perpendicular to one another.

9. The device of claim 1, wherein the hopper is mounted on a pair of wheels and the arms are mounted on at least one shaft, the shaft being attached to at least one of the wheels such that the shaft is rotated by the wheels.

10. An agricultural spreading device, comprising:
a hopper having a bottom surface with a plurality of elongated slots, the hopper having an inclined surface leading into the bottom surface;
a dispensing device arranged in the hopper adjacent to the bottom surface, the dispensing device having a plurality of rotatable arms for engaging a spreadable material;
a baffle mounted in the hopper for limiting advancement of the spreadable material toward the elongated slots, the baffle being rotatable between a first position where a bottom edge of the baffle engages the inclined surface and a second position where a gap is created between the inclined surface and the bottom edge;
a slideable dispensing plate mounted to the hopper adjacent to the bottom surface, the dispensing plate having a plurality of dispensing slots corresponding to the elongated slots; and
a plate actuating mechanism attached to the dispensing plate that positions the dispensing slots relative to the elongated slots.

11. The device of claim 10, wherein the bottom surface and the dispensing plate have an arcuate configuration.

12. The device of claim 10, wherein the dispensing slots are substantially the same shape and size as the elongated slots.

13. The device of claim 10, wherein the dispensing plate contacts the bottom surface of the hopper.

14. The lever of claim 10, further comprising brackets attached to the hopper, the dispensing plate being supported by the brackets.

15. The device of claim 10, wherein the plate actuating mechanism includes a lever attached to the dispensing plate by a control rod such that movement of the lever slides the dispensing plate.

16. The device of claim 15, wherein the plate actuating mechanism includes a support member, the support member having a plurality of positioning apertures, the lever having a positioning projection that engages the positioning apertures.

17. The device of claim 16, further comprising a limit stop that limits the movement of the lever.

18. The device of claim 16, further comprising a biasing member that biases the lever toward the support member.
